(19) United States
(12) Patent Application Publication
(10) Pub. No.: US 2006/0262738 A1
(43) Pub. Date: Nov. 23, 2006

(54) Administering acknowledgment messages in the transmission control protocol

(76) Inventors: Lilian Fernandes, Austin, TX (US); Vinit Jain, Austin, TX (US); Ketan P. Pancholi, Austin, TX (US); Venkat Venkatsubra, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/130,694

(22) Filed: May 17, 2005

(51) Int. Cl. H04B 1/44; H04L 12/56

(52) U.S. Cl. 370/282; 370/395.2

(57) ABSTRACT

Administering acknowledgment messages (‘ACKs’) in the Transmission Control Protocol (“TCP”) that include establishing a TCP connection between a sender and a receiver, receiving by the receiver one or more TCP messages from the sender, and transmitting an ACK from the receiver to the sender only when necessary. Administering ACKs in TCP according to embodiments of the present invention may include measuring by the sender a round trip time for transmission of TCP messages between the sender and the receiver and transmitting to the receiver a data-bearing TCP message once per round trip time. Establishing a TCP connection between a sender and a receiver may include measuring by the receiver a round trip time for transmission of TCP messages between the receiver and the sender. Transmitting an ACK only when necessary may include transmitting an ACK when no message from the sender arrives at the receiver for two round trip times.

### BACKGROUND OF THE INVENTION

1. Field of the Invention

The field of the invention is data processing, or, more specifically, methods, systems, and products for administering acknowledgment messages (‘ACKs’) in the Transmission Control Protocol.

2. Description of Related Art

The Transmission Control Protocol (‘TCP’) is a connection-oriented, end-to-end reliable protocol designed to fit into a layered hierarchy of protocols which support multi-network applications. TCP is described in its original specification, the well-known RFC793, as a connection-oriented, end-to-end reliable protocol designed to fit into a layered hierarchy of protocols which support multi-network applications. TCP provides for reliable inter-process communication between pairs of processes in host computers attached to distinct but interconnected computer communication networks. Very few assumptions are made as to the reliability of the communication protocols below the TCP layer. TCP assumes it can obtain a simple, potentially unreliable datagram service from the lower level protocols. In principle, the TCP should be able to operate above a wide spectrum of communication systems ranging from hard-wired connections to packet-switched or circuit-switched networks.

In traditional TCP, a receiver sends an acknowledgement message or ‘ACK’ for every TCP message received through a connection from a sender. A huge proportion of these messages contain no more information than the next-expected sequence number, which is also tracked by the sender, and is accurate so long as nothing goes wrong. Things do go wrong. Messages are lost or arrive late and out of order. Receive windows change in size, possibly reducing entirely to zero. And so on. Still it seems that many ACK messages serve little substantive purpose.

In fact, reducing the number of ACKs has long been of interest to researchers in data communications. Here is a comment by David Clark of the MIT Laboratory for Computer Science from RFC813, July, 1982:
Measurement of TCP implementations, especially on large operating systems, indicate that most of the overhead of dealing with a segment is not in the processing at the TCP or IP level, but simply in the scheduling of the handler which is required to deal with the segment. A steady dribble of acknowledgements causes a high overhead in scheduling, with very little to show for it. This waste is to be avoided if possible.

### SUMMARY OF THE INVENTION

Methods, systems, and products are described for administering acknowledgment messages (‘ACKs’) in the Transmission Control Protocol (“TCP”) that include establishing a TCP connection between a sender and a receiver, receiving by the receiver one or more TCP messages from the sender, and transmitting an ACK from the receiver to the sender only when necessary. Administering ACKs in TCP according to embodiments of the present invention may include measuring by the sender a round trip time for transmission of TCP messages between the sender and the receiver and transmitting to the receiver a data-bearing TCP message once per round trip time.

Establishing a TCP connection between a sender and a receiver may include measuring by the receiver a round trip time for transmission of TCP messages between the receiver and the sender, and transmitting an ACK only when necessary may include transmitting an ACK when no message from the sender arrives at the receiver for two round trip times.

A receiver may include a receive window having a receive window size, and transmitting an ACK only when necessary may include transmitting an ACK when the receive window size changes. A sender may store contents of unacknowledged previously sent messages in a retransmit buffer and set the size of the retransmit buffer at least four times the size of the receive window. Transmitting an ACK only when necessary may also be implemented by transmitting an ACK when a message is received from the sender out of order.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for administering acknowledgment messages in TCP according to embodiments of the present invention.

FIG. 2 sets forth a block diagram of automated computing machinery comprising an exemplary computer useful in administering acknowledgment messages in TCP according to embodiments of the present invention.

FIG. 3 sets forth a calling sequence diagram and flow chart illustrating an exemplary method for administering acknowledgment messages in TCP according to embodiments of the present invention.

FIG. 4 sets forth a calling sequence diagram and flow chart illustrating a further exemplary method for administering acknowledgment messages in TCP according to embodiments of the present invention.

FIG. 5 sets forth a calling sequence diagram and flow chart illustrating a still further exemplary method for administering acknowledgment messages in TCP according to embodiments of the present invention.

FIG. 6 sets forth a calling sequence diagram and flow chart illustrating an even further exemplary method for administering acknowledgment messages in TCP according to embodiments of the present invention.

### DETAILED DESCRIPTION OF EXEMPLARY EMBODIMENTS

### Introduction

The present invention is described to a large extent in this specification in terms of methods for administering acknowledgment messages in TCP. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

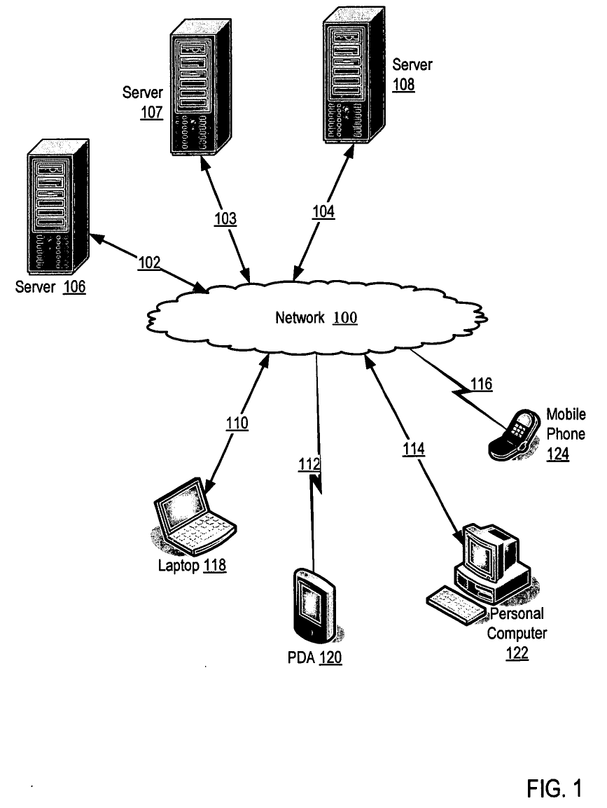

Exemplary methods, systems, and products for administering acknowledgment messages in TCP according to embodiments of the present invention are described with reference to the accompanying drawings, beginning with FIG. 1. FIG. 1 sets forth a network diagram illustrating an exemplary system for administering acknowledgment messages in TCP according to embodiments of the present invention. The system of FIG. 1 operates generally to administer acknowledgment messages in TCP according to embodiments of the present invention by establishing a TCP connection between a sender and a receiver, receiving by the receiver one or more TCP messages from the sender, and transmitting an ACK from the receiver to the sender only when necessary.

The system of FIG. 1 includes a network (100) that provides data communications among senders and receivers of TCP messages. Network (100) is any aggregation of software and computer hardware capable of receiving and transmitting messages in the network layer of the ISO protocol stack. Network (100) typically is a packet switching network implemented with routers, computer capable of transmitting messages through the network of routers according to a network communications protocol, shared routing tables, and routing algorithms. Network (100) is not required to be, but as a practical matter often is, an Internet Protocol (‘IP’) network. Segments of control data and message data transmitted on network (100) in its network protocol are referred to as ‘packets.’ Network (100) is typically ‘unreliable,’ meaning that its protocol does not require it to deliver packets in order, nor indeed to deliver them at all.

Delivering messages reliably and in sequence is the responsibility of the next layer of the ISO stack, in this example, TCP. In this specification, a segment of data transmitted according to TCP is referred to as a ‘TCP message,’ or simply as a ‘message.’ TCP is a connection-oriented protocol, meaning that a sender and a receiver of TCP messages establish a connection between the sender and receiver for the duration of an exchange of messages. The application programming interface (‘API’) between an application and TCP is called ‘sockets.’ An instance of a socket includes data describing a network address and a port number that identifies a data communications application program (an email client or a browser, for example) on a sender or a receiver. Controlling reliability and message sequence requires TCP to initialize and maintain certain status information for each stream of data communications. The combination of this information, including sockets, sequence numbers, receive window sizes, and so on, is called a connection. Each connection may be uniquely specified by a pair of sockets identifying its two sides, a sender and a receiver.

The system of FIG. 1 includes several servers (106, 107, 108) and several other automated devices, a laptop computer (118), a personal digital assistant (120), a personal computer (122), and mobile telephone (124). The servers are coupled to network (100) for data communications through wireline connections (102, 103, 104). Laptop (118) is coupled for data communications to network (100) through wireline connection (100). PDA (120) is coupled for data communications to network (100) through wireless connection (112). Personal computer (122) is coupled for data communications to network (100) through wireline connection (114). And mobile phone (124) is coupled for data communications to network (100) through wireless connection (116). In terms of data communication application programs, browsers, email, and the like, laptops, PDAs, personal computers, and mobile phone may often be considered ‘client’ devices, that is, devices that request services from servers and receive responses in return. Similarly, a computer that houses an email service or a web service is often considered a ‘server’ in the sense that it receives requests for services and provides responses in return. Examples of such servers includes email servers and web servers.

It is useful to note, however, that whether a particular device is considered a client or a server depends upon its role at the moment. Server (106), acting as a web server, may receive from personal computer (122) a request for a web page, for example, in which case, server (106) is acting as a web server. Fulfilling the request may require server (106) to transmit an HTTP request to server (107), in which case server (106) acts as a client.

Administration of acknowledgment messages in TCP according to embodiments of the present invention include computer operation of a TCP module improved for administration of acknowledgment messages according to embodiments of the present invention. Just as a device may be considered a server or a client according to its role at the moment, so also a device may be considered a TCP sender or a TCP receiver according to its role at the moment. Each device that implements a TCP module improved for administration of acknowledgment messages according to embodiments of the present invention typically implements the entire module, including provisions for both sending and receiving TCP messages. That is, TCP connections between devices implementing TCP modules improved to administer acknowledgment messages according to embodiments of the present invention typically are bidirectional. So every device in FIG. 1 may operate either as a sender or as a receiver or as both a sender and receiver during any particular connection.

The arrangement of the network, servers, and other devices making up the exemplary system illustrated in FIG. 1 are for explanation, not for limitation. Data processing systems useful for administering acknowledgment messages in TCP according to various embodiments of the present invention may include additional servers, routers, other devices, and even peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

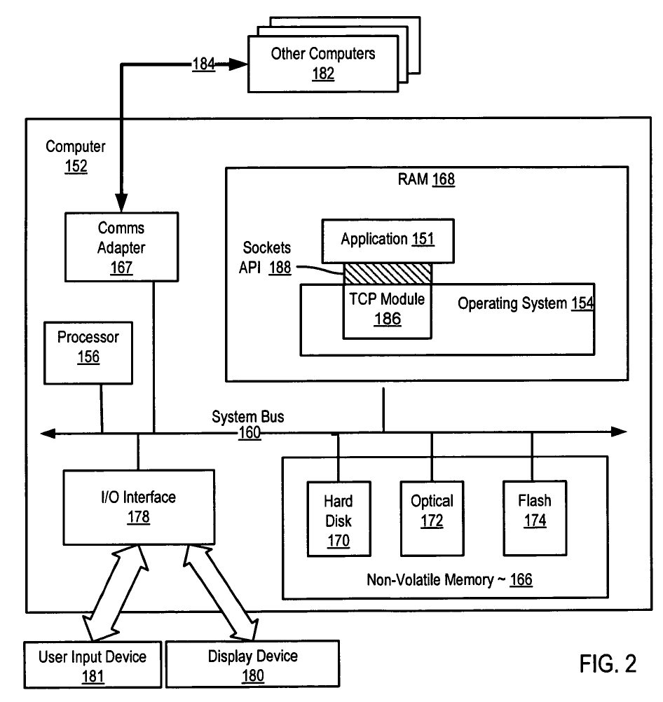

Administering acknowledgment messages in TCP in accordance with the present invention is implemented generally with computers, that is, with automated computing machinery. In the system of FIG. 1, for example, the network, the servers, and the other devices are implemented to some extent at least as computers. For further explanation, therefore, FIG. 2 sets forth a block diagram of automated computing machinery comprising an exemplary computer (152) useful in administering acknowledgment messages in TCP according to embodiments of the present invention. The computer (152) of FIG. 2 includes at least one computer processor (156) or ‘CPU’ as well as random access memory (168) (“RAM”) which is connected through a system bus (160) to processor (156) and to other components of the computer.

Stored in RAM (168) is a TCP module (186), computer program instructions for TCP communications generally including improvements for administering acknowledgment messages in TCP according to embodiments of the present invention. Also stored in RAM (168) is an application program (151), computer program instructions that include the use of TCP for data communications. Examples of such application programs include a data communications client such as a browser, for example, or a data communications server, such as a web server, for example. TCP module (186) exposes a sockets API (188) supporting subroutine calls from application program (151) to TCP module (186).

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), TCP module (186), and application program (105) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

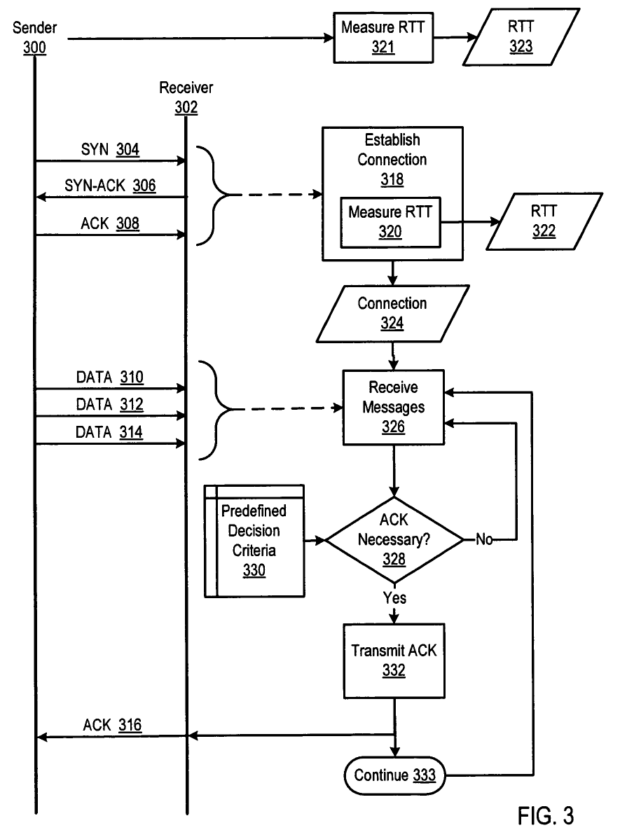

For further explanation, FIG. 3 sets forth a calling sequence diagram and flow chart illustrating an exemplary method for administering acknowledgment messages in TCP according to embodiments of the present invention that includes establishing (318) a TCP connection (324) between a sender (300) and a receiver (302). Sender and receiver establish a TCP connection with a three-way handshake that includes a request (304) from sender to establish a connection, an acknowledgement of the request from the receiver coupled with a similar request on the part of the receiver, and an acknowledgment from the sender of the receiver's request. The sender's connection request is represented as a TCP SYN message. Each participant orders all the octets or bytes of data to be sent over the connection with sequence numbers. A TCP SYN message is a request to ‘synchronize’ a connection in this sense: because it includes an initial sequence number for data to be sent through the connection. The sequence number of the first byte of data through the connection then is the initial sequence number plus one. Both participants, the sender and the receiver, may send data; both participants therefore synchronize by sending a SYN message bearing an initial sequence number, one initial sequence number each for both the sender and receiver.

A TCP message includes a header and a body of data. The header contains information that aids TCP modules in establishing a connection and administering data communications through a connection. The header includes, among other things:
A control bit named ‘SYN.’ When SYN is set, the message is a synchronization request, part of a connection-creating three-way handshake.
A sequence number field. The sequence number field identifies the sequence number of the first byte of data in a TCP message, except in a SYN message. A SYN message is a message with its SYN control bit set. In a SYN message, the value in the sequence number field is the ‘initial sequence number’ and the sequence number of the first byte of data is the initial sequence number plus one.
A control bit named ‘ACK.’ When ACK is set, the acknowledgment number field is significant.
An acknowledgment number field. If the ACK control bit is set, this field contains the value of the next sequence number the sender of the message is expecting to receive.
A window field. The value of the window field is the number of bytes of data, beginning with the byte having the sequence number indicated in the acknowledgment field, that the sender of a message is willing to accept.

Describing connection-initiation messages and messages containing data, both of which may flow in both directions through a connection, bears some risk of confusion. For clarity of explanation in this specification, therefore, the transmission of data through a connection is viewed generally in one direction only, as if it were sent from a computer designated a ‘sender’ to another computer designated a ‘receiver.’ This unidirectional view of flow through a connection is for clarity of explanation only, not a limitation of the present invention. Readers will recognize that both participants in data communications through a connection may send and receive control messages and data through the same connection.

In the method of FIG. 3, establishing (318) a TCP connection (324) includes measuring (320) by the receiver a round trip time (322) for transmission of TCP messages between the receiver and the sender. Receiver (302) may measure a round trip time by subtracting the time when an ACK (308) message is received from sender (300) from the time when a corresponding SYN-ACK (306) message was sent, for example.

The method of FIG. 3 also includes receiving (326) by the receiver one or more TCP messages from the sender. With a connection established by a handshake, sender proceeds to send a series of TCP messages containing the data which are the subject of the data communications connection. A segment of data longer than a maximum message size is broken into a series of messages (310, 312, 314). For clarity of explanation, only three such messages are illustrated in FIG. 3, but readers will recognize that any number of messages containing data may be transmitted through a TCP connection.

In addition, the method of FIG. 3 also includes measuring (321) by the sender a round trip time (323) for transmission of TCP messages between the sender and the receiver. The sender may, for example, measure the round trip time as the difference in a three-way handshake between the time when a SYN-ACK message (306) is received and the time when the corresponding SYN message (304) was sent. Sender (300) in this example then transmits to the receiver a data-bearing TCP message (310, 312, 314) once per round trip time. In prior art, sender would have waited between transmissions for an ACK from receiver. In the example of FIG. 3, sender sends another message each round trip time, without waiting for an ACK for each message so sent.

The method of FIG. 3 also includes transmitting (332) an ACK from the receiver to the sender only when necessary. The method of FIG. 3 includes determining (328) whether an ACK is necessary in dependence upon predefined decisions criteria, described in more detail below. Predefined decision criteria (330) may include, for example, whether a message has been received from a sender within two round trip times.

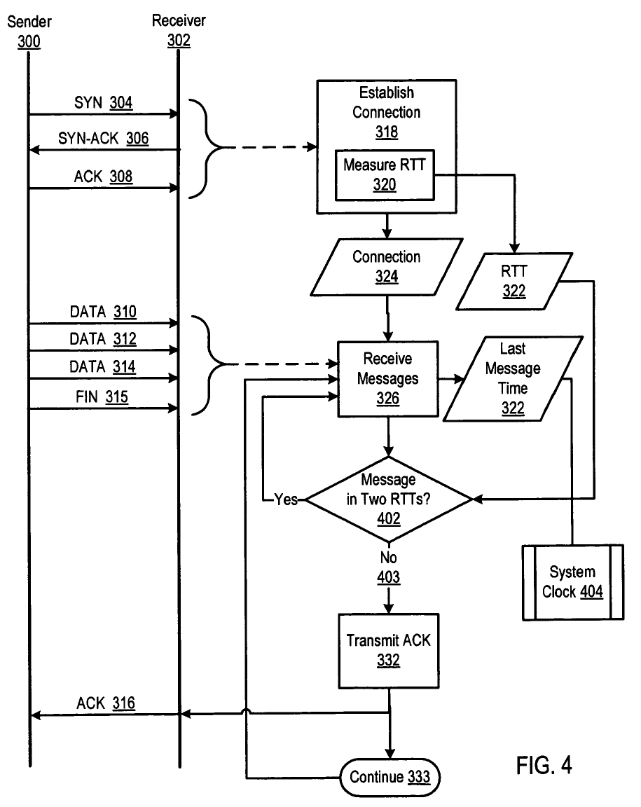

For further explanation, FIG. 4 sets forth a calling sequence diagram and flow chart illustrating a further exemplary method for administering acknowledgment messages in TCP according to embodiments of the present invention. The method of FIG. 4 is similar to the method of FIG. 3. That is, the method of FIG. 4 includes establishing (318) a TCP connection (324), receiving (326) TCP messages from a sender, and transmitting (332) an ACK from a receiver to the sender only when necessary, all of which are carried out generally as described above with reference to FIG. 3. In the method of FIG. 4, however, transmitting (332) an ACK only when necessary is carried out by transmitting an ACK when no message from the sender arrives at the receiver for two round trip times.

The method of FIG. 4 includes determining (402) whether a message has arrived within two round trip times. Determining (402) whether a message has arrived within two round trip times may be implemented, for example, by periodically comparing the time when a last message was received with the current time from a system clock (404). When the difference between the time when a last message was received and the current time exceeds two round trip times (403), the method of FIG. 4 transmits (332) an ACK (316) to the sender (300).

In this example, sender (300) sends messages (310, 312, 314) at the rate of one message per round trip time. If two round trip times have expired since the last message received, a message may have been lost. Sending an ACK bearing the sequence number of the missing message causes sender to retransmit the missing message. If the missing message is received later (because it was not missing, it was merely very slow), receiver (302) discards it. If the missing message arrives after the expiration of two round trip times but before its retransmission, the receiver discards the retransmission.

The method of FIG. 4 also illustrates termination of a connection in systems for administering acknowledgment messages according to embodiments of the present invention. In the example of FIG. 4, messages from the sender include a FIN message (315). The control bits in a TCP message header include a control bit named ‘FIN.’ A message with the FIN bit set indicates that no more data will be sent from a sender for the current connection. In traditional TCP communications, receiver (302) would acknowledge the receipt of a FIN message with an ACK. The method of FIG. 4, however, responds with ACKs only when necessary, the necessity determined by predefined decision criteria. In this example, there are no predefined decision criteria for FIN messages. The receiver therefore transmits no ACK upon receiving FIN message (315). From the view point of the sender (300), however, the current data communications are finished. The sender may respond with an ACK to a FIN from receiver (302), but otherwise, no further messages are coming from sender (300) through the current connection. Therefore, two round trip times expire with no new message from the sender (300), and receiver transmits (332) the ACK (316), which from the sender's point of view corresponds to FIN message (315).

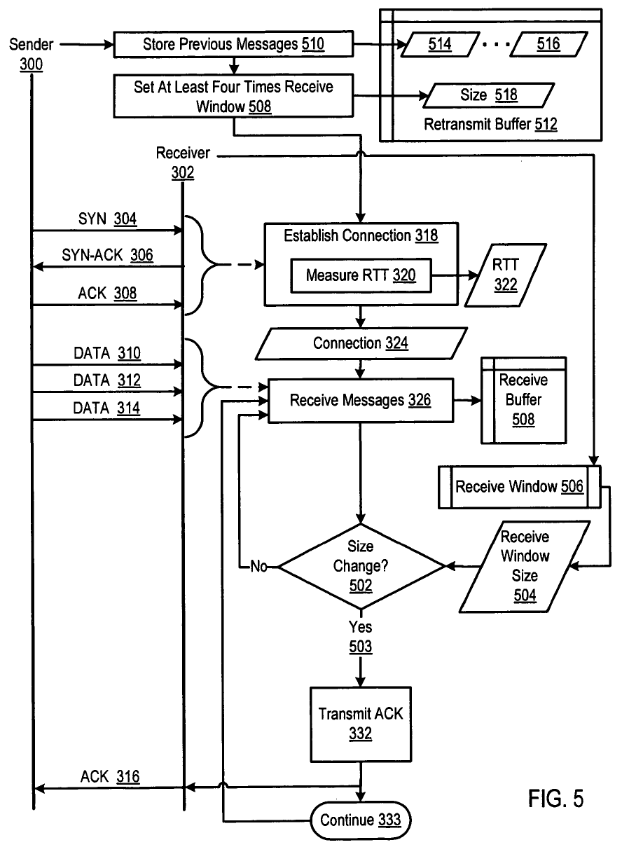

For further explanation, FIG. 5 sets forth a calling sequence diagram and flow chart illustrating a still further exemplary method for administering acknowledgment messages in TCP according to embodiments of the present invention. The method of FIG. 5 is similar to the method of FIG. 3. That is, the method of FIG. 5 includes establishing (318) a TCP connection (324), receiving (326) TCP messages from a sender, and transmitting (332) an ACK from a receiver to the sender only when necessary, all of which are carried out generally as described above with reference to FIG. 3. In the method of FIG. 5, however, transmitting (332) an ACK only when necessary is carried out by transmitting an ACK when a receive window size changes.

A receive window is the number of bytes of data that a receiver is willing to accept from a sender. The sender is advised of the size of the receive window in the window field of TCP messages. In prior art, a receiver that receive the data-bearing message (310, 312, 314), for example, would typically respond to each of these messages with an ACK message confirming receipt of the messages and advising the current size of the receive window. Many such ACK messages may be viewed as redundant because the size of the receive window may not be changed very often, although it is useful for the sender to know when the size of the receive window does change. In the method of FIG. 5, ACK messages are not transmitted to acknowledge each message received from a sender. Instead, ACK messages are transmitted only when necessary. More particularly in the example of FIG. 5, receiver (302) includes a receive window (506) having a receive window size (504). The method of FIG. 5 includes detecting (502) changes in the size of the receive window. In the method of FIG. 5, transmitting (332) an ACK only when necessary is carried out by transmitting an ACK when the receive window size changes (503).

The method of FIG. 5 also includes storing (510) by the sender contents of unacknowledged previously sent messages (514-516) in a retransmit buffer (512). TCP is typically implemented over an unreliable network protocol, usually the Internet Protocol (‘IP’). Unreliable network protocols simply drop packets of data from time to time for various reasons without informing their clients in the transmission layer that they are doing so. Some TCP messages therefore simply disappear in the network layer, and it is up to TCP to provide reliability. In support of reliability, TCP modules typically maintain storage of messages already transmitted in case the messages are lost in by unreliable network layer protocol and need to be retransmitted. In sending ACKs when necessary according to embodiments of the present invention, receiver (302) may send an ACK when two round trip times expire without a new message from sender (300), as explained above with reference to the method of FIG. 4. Such an ACK message advises the sender of the sequence number of the next data byte the receiver is expecting to receive. The sender may then begin retransmission from that sequence number in its retransmit buffer (512). In this example, sender will not receive such an ACK message until two round trip times have expired. In the meantime, sender may transmit a window of data per trip time, two per round trip time. Sender (300) therefore sets (508) the size (518) of its retransmit buffer (512) to at least four times the size (504) of the receive window (506). When sender receives an ACK (316) advising that the size (504) of the receive window has changed, sender may adjust the size (518) of its retransmit buffer (512) to hold at least four times the new size of the receive window.

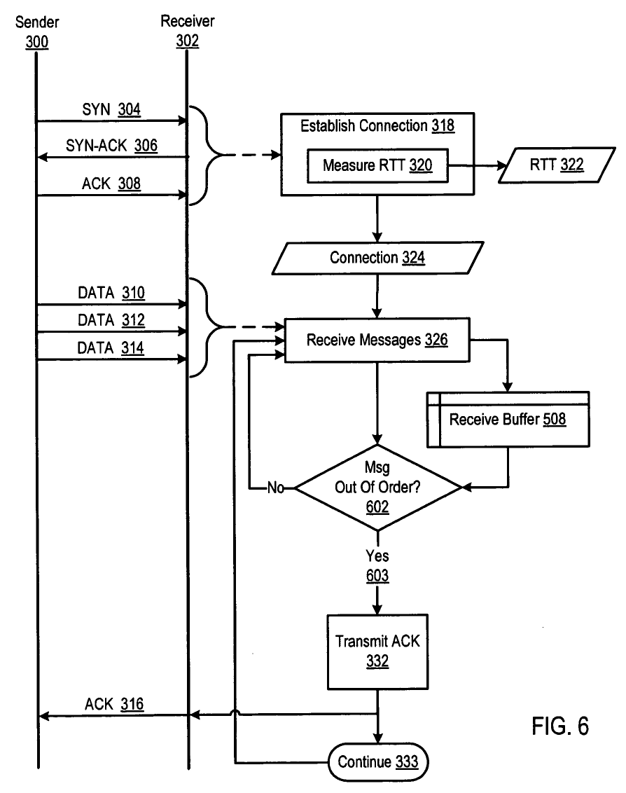

For further explanation, FIG. 6 sets forth a calling sequence diagram and flow chart illustrating an even further exemplary method for administering acknowledgment messages in TCP according to embodiments of the present invention. The method of FIG. 6 is similar to the method of FIG. 3. That is, the method of FIG. 6 includes establishing (318) a TCP connection (324), receiving (326) TCP messages from a sender, and transmitting (332) an ACK from a receiver to the sender only when necessary, all of which are carried out generally as described above with reference to FIG. 3. In the method of FIG. 6, however, transmitting (332) an ACK only when necessary is carried out by transmitting an ACK when a message is received from the sender out of order. A sequence number field in a TCP message identifies the sequence number of the first byte of data in the message. The sequence number expected by the receiver is the sequence number of the last message received plus the number of data bytes transmitted in that message. If the sequence number of an incoming message is larger than the sequence number expected by the receiver, the receiver determines that a message has been received out of order.

In the method of FIG. 6, receiver (302) maintains a receive buffer (508) for storage of received messages. Receiver (302) stores received messages in the receive buffer temporarily to assure that all messages are received in correct order. The method of FIG. 6 includes the receiver's determining (602) whether a message has been received out of order. The receiver may make this determination by examining the sequence numbers and the sizes of the data blocks in the messages in the receiver buffer. When a message is received out of order (603), receiver (302) transmits (332) to sender (300) an ACK (316), a TCP message with its ACK bit set, bearing in its acknowledgment number field the sequence number of the next data byte the receiver is expecting to receive.

In view of the explanations set forth above in this specification, readers will recognize that the benefits of administering acknowledgement messages for TCP according to embodiments of the present invention include:
The effective elimination of all ACK messaging merely to advise a sender of receipt of a message,
and therefore a substantial reduction in overall network traffic,
through a method that is essentially self-regulating: The number of ACKs is greatly reduced on a busy connection, and ACK activity is more or less normal on an idle connection.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for administering acknowledgment messages (‘ACKs’) in the Transmission Control Protocol (“TCP”), the method comprising:
establishing a TCP connection between a sender and a receiver;
receiving by the receiver one or more TCP messages from the sender; and
transmitting an ACK from the receiver to the sender only when necessary.

2. The method of claim 1 further comprising:
measuring by the sender a round trip time for transmission of TCP messages between the sender and the receiver; and
transmitting to the receiver a data-bearing TCP message once per round trip time.

3. The method of claim 1 wherein:
establishing a TCP connection between a sender and a receiver further comprises measuring by the receiver a round trip time for transmission of TCP messages between the receiver and the sender; and
transmitting an ACK only when necessary further comprises transmitting an ACK when no message from the sender arrives at the receiver for two round trip times.

4. The method of claim 1 wherein:
the receiver includes a receive window having a receive window size; and
transmitting an ACK only when necessary further comprises transmitting an ACK when the receive window size changes.

5. The method of claim 1 wherein the receiver includes a receive window having a receive window size, the method further comprising:
storing by the sender contents of unacknowledged previously sent messages in a retransmit buffer; and
setting the size of the retransmit buffer at least four times the size of the receive window.

6. The method of claim 1 wherein transmitting an ACK only when necessary further comprises transmitting an ACK when a message is received from the sender out of order.

7. A system for administering acknowledgment messages (‘ACKs’) in the Transmission Control Protocol (“TCP”), the system comprising:
means for establishing a TCP connection between a sender and a receiver;
means for receiving by the receiver one or more TCP messages from the sender; and
means for transmitting an ACK from the receiver to the sender only when necessary.

8. The system of claim 7 further comprising:
means for measuring by the sender a round trip time for transmission of TCP messages between the sender and the receiver; and
means for transmitting to the receiver a data-bearing TCP message once per round trip time.

9. The system of claim 7 wherein:
means for establishing a TCP connection between a sender and a receiver further comprises means for measuring by the receiver a round trip time for transmission of TCP messages between the receiver and the sender; and
means for transmitting an ACK only when necessary further comprises means for transmitting an ACK when no message from the sender arrives at the receiver for two round trip times.

10. The system of claim 7 wherein:
the receiver includes a receive window having a receive window size; and
means for transmitting an ACK only when necessary further comprises means for transmitting an ACK when the receive window size changes.

11. The system of claim 7 wherein the receiver includes a receive window having a receive window size, the system further comprising:
means for storing by the sender contents of unacknowledged previously sent messages in a retransmit buffer; and
means for setting the size of the retransmit buffer at least four times the size of the receive window.

12. The system of claim 7 wherein means for transmitting an ACK only when necessary further comprises means for transmitting an ACK when a message is received from the sender out of order.

13. A computer program product for administering acknowledgment messages (‘ACKs’) in the Transmission Control Protocol (“TCP”), the computer program product comprising:
a recording medium;
means, recorded on the recording medium, for establishing a TCP connection between a sender and a receiver;
means, recorded on the recording medium, for receiving by the receiver one or more TCP messages from the sender; and
means, recorded on the recording medium, for transmitting an ACK from the receiver to the sender only when necessary.

14. The computer program product of claim 13 further comprising:
means, recorded on the recording medium, for measuring by the sender a round trip time for transmission of TCP messages between the sender and the receiver; and
means, recorded on the recording medium, for transmitting to the receiver a data-bearing TCP message once per round trip time.

15. The computer program product of claim 13 wherein:
means, recorded on the recording medium, for establishing a TCP connection between a sender and a receiver further comprises means, recorded on the recording medium, for measuring by the receiver a round trip time for transmission of TCP messages between the receiver and the sender; and
means, recorded on the recording medium, for transmitting an ACK only when necessary further comprises means, recorded on the recording medium, for transmitting an ACK when no message from the sender arrives at the receiver for two round trip times.

16. The computer program product of claim 13 wherein:
the receiver includes a receive window having a receive window size; and
means, recorded on the recording medium, for transmitting an ACK only when necessary further comprises means, recorded on the recording medium, for transmitting an ACK when the receive window size changes.

17. The computer program product of claim 13 wherein the receiver includes a receive window having a receive window size, the computer program product further comprising:
means, recorded on the recording medium, for storing by the sender contents of unacknowledged previously sent messages in a retransmit buffer; and
means, recorded on the recording medium, for setting the size of the retransmit buffer at least four times the size of the receive window.

18. The computer program product of claim 13 wherein means, recorded on the recording medium, for transmitting an ACK only when necessary further comprises means, recorded on the recording medium, for transmitting an ACK when a message is received from the sender out of order.
